(19) United States
(12) Patent Application Publication
(10) Pub. No.: US 2003/0005919 A1
(43) Pub. Date: Jan. 9, 2003

(54) Device and method for separating materials

(76) Inventors: Ralf Hammer, Freiberg (DE); Ralf Gruszynsky, Brand-Erbisdorf (DE); Andre Kleinwechter, Freiberg (DE); Tilo Flade, Freiberg (DE)

Correspondence Address: Edwards & Angell, Dike Bronstein Roberts & Cushman, Intellectual Property Practice Group, PO Box 9169, Boston, MA, 02209, US

(21) Appl. No.: 10/181,099

(22) PCT Filed: Oct. 17, 2001
(86) PCT No.: PCT/EP01/12032

(30) Foreign Application Priority Data
Nov. 8, 2000 (DE) 100 55 286.2

(51) Int. Cl. B28D 1/04

(52) U.S. Cl. 125/13.01

(57) ABSTRACT

A method and a device for the division of materials, in particular of single crystals, in particular by inner hole cutting is provided, with a cutting disk (2) having a concentric hole whose edge (3) forms a cutting edge and wherein the cutting disk (2) is rotatable about its central axis in order to cut the single crystal (1), a positioning device for positioning the single crystal (1) to be cut relative to the cutting disk in such a way that the cutting disk moves in rotating manner through the single crystal in order to separate off a part (1a) of the single crystal (1), and a device for the supply of coolant-lubricant onto the cutting disk (2), wherein the device (10) for the supply of coolant-lubricant is arranged in such a way that viewed in the direction of rotation it supplies the coolant-lubricant on the exit side behind the passage of the cutting disk (2) through the single crystal (1), and a device for the supply of compressed air (12).

The invention relates to a device and a method for the division of materials, in particular of single crystals.

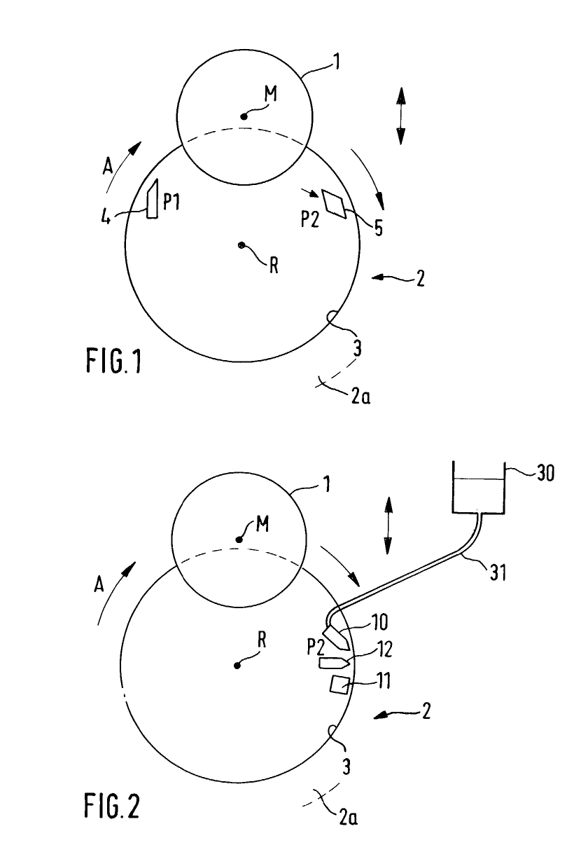

Inner hole cutting is a known method for the division of single crystals, which is employed in particular for the production of semiconductor wafers. FIG. 1 is a schematic illustration for the inner hole cutting of a single crystal 1 seen in a plan view in the direction of the central longitudinal axis M. As can be seen in FIG. 1 the single crystal 1, which is of substantially cylindrical construction with a central longitudinal axis M, is fitted on a mounting which is not shown and together with the latter can be moved in a direction perpendicular to the central longitudinal axis M by means of an advancement device which is not shown. To divide or cut the wafers a cutting disk 2 is provided which consists of a core metal sheet 2a possessing a concentric inner hole whose edge 3 surrounding the inner hole is occupied by diamond particles and thus forms a cutting edge. The width of the core metal sheet between its outer edge and its inner edge is greater than the diameter of the single crystal for which reason only the inner edge is illustrated schematically in the figure. The cutting disk 2 can be rotated via a drive about its central axis R in the direction A shown in FIG. 1. The cutting disk and the single crystal are arranged relative to one another in such a way that the axis of rotation R of the cutting disk 2 and the central longitudinal axis M of the single crystal 1 run parallel to one another at a distance. Furthermore, by means of the advancement device the single crystal 1 is movable at right angles to its central longitudinal axis M in the direction towards the cutting disk 2 in such a way that in rotating the cutting disk cuts through the single crystal 1 completely in a plane perpendicular to its central longitudinal axis M, and can be moved away from the cutting disk 2 into a position in which a separated wafer can be removed.

Inside the edge 3 of the cutting disk 2 surrounding the inner hole, ahead of the position P1 in the direction of rotation A where the cutting disk enters the single crystal 1, referred to below as the entry side, a coolant-lubricant feed device 4 is provided for feeding coolant-lubricant onto the cutting edge. Following the position P2 in the direction of rotation A where the cutting disk emerges from the single crystal 1, referred to below as the exit side, a second feed device for coolant-lubricant is provided. In operation, before entry of the cutting disk 2 into the single crystal 1 the coolant-lubricant is applied to the cutting edge or the cutting disk 2 via the feed device 4 which then due to rotation of the cutting disk 2 is transported into the cutting gap produced during cutting. When the cutting disk 2 emerges from the single crystal 1 coolant-lubricant is applied once more by the second feed device 5 so that cleaning and transport away of stripped material through the cutting gap is ensured. Additives are added to the coolant-lubricant which reduce surface tension and hence improve the wetting of the cutting disk. The known device further possesses a device for rinsing the core metal sheet and clamping system at intervals.

In the known device there is the problem that effective cleaning and the transport away of stripped material during cutting requires so much coolant-lubricant that the cutting gap becomes filled with coolant-lubricant and stripped material. As a result of this it can happen in the case of narrow cutting gaps that there is contact between the core metal sheet of the cutting disk 2 and the wafer section. The wafer section is drawn onto the core metal sheet by adhesion and the quality of the wafer separated off is adversely affected. When the contact surface areas are large it can happen that the wafer is torn away. If, on the other hand, the quantity of coolant-lubricant is too low the cleaning and transport action is no longer sufficient. Moreover, additives reducing surface tension result in better wetting of the core metal sheet which promotes evaporation and drying of the cutting slurry on the core metal sheet.

The aim of the invention is to provide a device and a method for the cutting of wafers by means of inner hole cutting both of which avoid the disadvantages described above.

The aim is achieved by a device in accordance with claim 1 or 14 and a method in accordance with claim 8 or 16.

Developments of the invention are specified in the subsidiary claims.

The device according to the invention and the method according to the invention exhibit in particular the advantage that during the cutting operation less coolant-lubricant is needed than in the known device. By this means a high-quality cut is produced.

Further characteristics and practical features of the invention emerge from the description of exemplified embodiments with reference to the figures.

The figures show:

FIG. 1 a schematic illustration of a known device seen in plan view in the direction of a single crystal longitudinal axis;

FIG. 2 a schematic illustration of an embodiment of the device according to the invention seen in plan view in the direction of the central longitudinal axis of the single crystal;

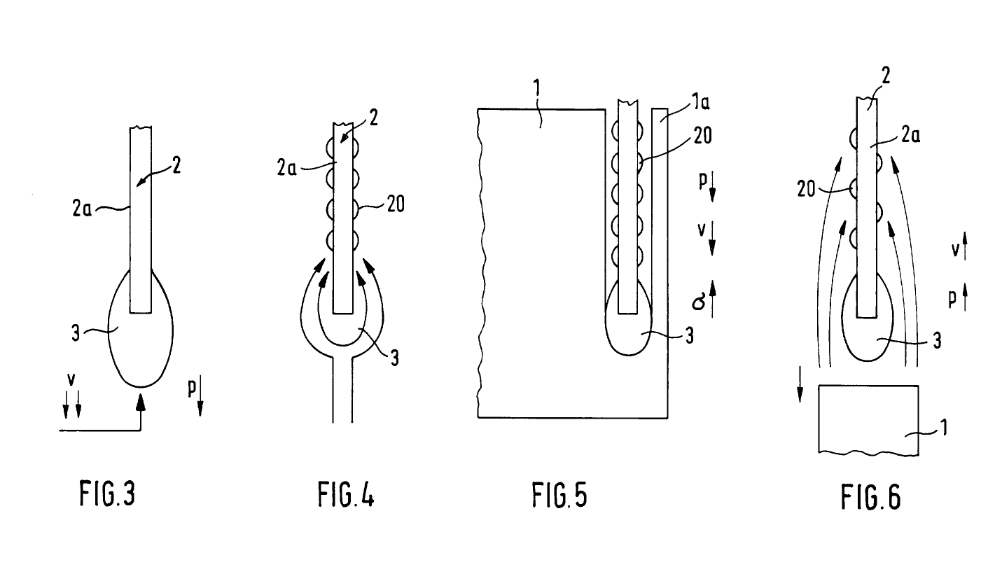

FIG. 3 a schematic illustration of the cooling step of the method according to the invention;

FIG. 4 a schematic illustration of a step of the spreading of the coolant-lubricant on the cutting tool before cutting;

FIG. 5 a schematic illustration of the cutting step; and

FIG. 6 a schematic illustration of the cleaning step in the method according to the invention.

As can be seen in FIG. 2 the device according to the invention exhibits in known manner the mounting and the advancement device for the single crystal 1 together with the cutting disk 2 with the core metal sheet 2a and the diamond-particle coated edge 3 of the inner hole of the cutting disk. In contrast with the known device the device according to the invention possesses a first feed device 10 for feeding coolant-lubricant onto the edge 3 of the inner hole and onto the cutting disk 2 which viewed in the direction of rotation of the cutting disk 2 is provided on the exit side at the position P2 after passage through the single crystal 1. The first feed device 10 for coolant-lubricant is constructed, by way of example, in the form of a nozzle. Furthermore, a second feed device 11 for cleaning agent is provided on the exit side in the region of the inner hole. In addition, a device 12 for feeding a gaseous medium, in particular compressed air, onto the cutting disk 2 and in particular the edge 3 is likewise provided on the exit side.

The operation of the device according to the invention and the method according to the invention may be seen in FIGS. 3 to 6. Prior to the cutting or dividing operation the cutting disk 2 and the single crystal 1 are separated from one another. The single crystal 1 is then moved relative to the cutting disk 2 and the latter in rotation bites into the material of the single crystal 1 in order to cut it. As shown in FIG. 3, during the separation operation coolant-lubricant at a low volume flow rate, ie at low speed v and low pressure p, is supplied to the edge 3 forming the cutting edge. The material used as coolant-lubricant is a coolant-lubricant containing an additive which increases the surface tension a of the coolant-lubricant and hence impairs the wetting of the core metal sheet 2a. As a result of this there is poor wetting of the core metal sheet 2a of the cutting disk 2 and droplets 20 of the coolant-lubricant form on the surface of the core metal sheet 2a. Likewise during the cutting operation, as shown in FIG. 4, compressed air from the source of compressed air 12 is blown onto the edge 3, as a result of which compensation is made for the poor wetting. The compressed air further contributes to the formation of droplets 20 and to the distribution of the same. As shown in FIG. 5, during the cutting operation the cutting disk 2 penetrates by the edge 3 and the droplets 20 of coolant-lubricant produced on the surface of the core metal sheet 2a into the single crystal 1 to cut off a wafer section la. Air and coolant-lubricant are steadily supplied at low pressure p. During the cutting time the droplets 20 of the coolant-lubricant on the core metal sheet 2a absorb the stripped material and spread it over the core metal sheet without the occurrence of drying or contact with the wafer.

After the cutting operation the single crystal 1 and the separated wafer are moved away from the cutting disk 2 via the advancement device so that the cutting disk and the single crystal or the separated wafer are separated from one another as shown in FIG. 6. The cleaning and the transport away of the material accumulated on the core metal sheet and enclosed in the droplets 20 is now carried out by supplying compressed air at high pressure p via the feed device 12 and by supplying at the same time cleaning agent in sufficient volume and at a relatively high rate v via the feed device 11.

Thus, the method according to the invention is a two-stage method in which during the cutting operation the cooling of the cutting tool, the swirling of the coolant, the encapsulation of the stripped material in the coolant-lubricant droplets and the distribution and retention of the coolant-lubricant droplets containing the stripped material ensues under the action of centrifugal force. In a second stage, after the single crystal has been moved away from the cutting disk, the cleaning and transport away of stripped material is carried out by means of high air pressure and an adequate supply of coolant-lubricant. The cleaning agent employed in the second stage can be identical with the coolant-lubricant, but it can also be another substance, such as water for example. In this way the coolant-lubricant and cleaning agent can have different properties.

In the method according to the invention very much less coolant-lubricant is needed for cooling and lubrication than for cleaning and removal of the stripped material. A high-quality cut can be achieved only with such a low amount of coolant-lubricant. During the actual cutting operation the amount of coolant-lubricant is set to the minimum amount required in order to guarantee cooling and lubrication. The cutting gap is clear and contact between the core metal sheet and wafer section is avoided. However, during cleaning a substantially higher volume flow rate is ideal. These requirements are contradictory. Accordingly, cooling and cleaning are separated in time from one another since different volume flow rates are optimal for both steps.

Instead of supplying compressed air it is also possible to supply a different gas, eg nitrogen.

In a preferred embodiment, as shown in FIG. 2 a container 30 for supplying the coolant-lubricant to the feed device 10, which delivers the low volume of coolant-lubricant during the cutting operation, is provided which in the working position is located at a constant height above the feed device 10 and is connected to the latter via a feed line 31. In the container is coolant-lubricant which is supplied to the feed device 10 via the feed line only under the action of gravity or the hydrostatic pressure. Air bubbles in the feed line are carried off upwards. In this way it is ensured that even when the quantities of coolant-lubricant to be delivered are low a steady and bubble-free supply is guaranteed.

The invention is suitable for the cutting of different materials, eg for optical glass, plastics and others.

1. Device for the division of materials, in particular of single crystals, having
a cutting disk (2) with a concentric hole whose edge (3) forms a cutting edge, the cutting disk (2) being rotatable about its central axis in order to cut the material (1),
a positioning device for positioning the material (1) to be cut relative to the cutting disk in such a way that during cutting the cutting disk moves in rotating manner through the material to separate off a part (1a) of the material (1), and
a device for the supply of coolant-lubricant onto the cutting disk (2),
characterised by a device (12) for the supply of a gaseous medium onto the cutting disk.

2. Device according to claim 1, characterised in that the device (10) for the supply of coolant-lubricant and the device (12) for the supply of a gaseous medium are arranged in such a way that the coolant-lubricant and the gaseous medium are supplied on the exit side behind the passage of the cutting disk (2) through the material (1).

3. Device according to claim 1 or 2, characterised in that on the exit side a device (11) for the supply of a cleaning agent, in particular coolant-lubricant, is provided.

4. Device according to one of claims 1 to 3, characterised in that the device (12) for the supply of a gaseous medium and/or the devices (10, 11) each have a nozzle which is constructed in such a way that the gaseous medium or the coolant-lubricant is applied onto the edge (3).

5. Device according to one of claims 1 to 4, characterised by a control system which actuates the feed device (10) during the cutting operation in such a way that only a small quantity of coolant-lubricant is supplied.

6. Device according to one of claims 1 to 5, characterised by a control system which actuates the further feed device (11) for the supply of cleaning agent after the cutting operation in such a way that a larger quantity of cleaning agent, in particular of coolant-lubricant, relative to the supply of coolant-lubricant during the cutting operation is supplied.

7. Device according to one of claims 1 to 6, characterised in that in the working position above the feed device (10) a storage container (30) for coolant-lubricant is provided which is connected to the feed device via a conduit (31), supply ensuing under the action of gravity.

8. Method for the division of materials, in particular for the inner hole cutting of single crystals, wherein the material (1) is divided by means of a cutting disk (2) penetrating into the material by rotation during the cutting operation, characterised in that a coolant-lubricant is supplied only on the exit side, viewed in the direction of rotation, behind the passage of the cutting disk (2) through the material (1).

9. Method according to claim 8, characterised in that during the cutting operation the cutting disk (2) is cooled and after the cutting operation is cleaned.

10. Method according to claim 9, characterised in that during cooling coolant-lubricant is supplied in a certain quantity and during cleaning coolant-lubricant is supplied in a greater quantity relative to the latter.

11. Method according to one of claims 8 to 10, characterised in that a gaseous medium, in particular compressed air, is supplied to the cutting disk (2).

12. Method according to claim 11, characterised in that, in the direction of rotation of the cutting disk, the gaseous medium is supplied after the emergence of the cutting disk from the material.

13. Method according to one of claims 8 to 12, characterised in that a coolant-lubricant containing an additive which increases the surface tension is employed.

14. Device for the division of materials, in particular of single crystals, having
a cutting disk (2) with a concentric hole whose edge (3) forms a cutting edge, the cutting disk (2) being rotatable about its central axis in order to cut the material (1),
a positioning device for positioning the material (1) to be cut relative to the cutting disk in such a way that during cutting the cutting disk moves in rotating manner through the material to separate off a part (1a) of the material (1),
a device (10) for the supply of coolant-lubricant onto the cutting disk (2),
a device (11) for the supply of cleaning agent onto the cutting disk (2), a control system being provided which controls the device (10) and the device (11) in such a way that coolant-lubricant is supplied during the cutting operation and cleaning agent is supplied after the cutting operation.

15. Device according to claim 14, wherein the control system is constructed in such a way that the coolant-lubricant is supplied at a low volume flow rate and the cleaning agent is supplied at a greater volume flow rate relative to the latter.

16. Method for the division of materials, in particular for the inner hole cutting of single crystals, wherein the material (1) is divided by means of a cutting disk (2) penetrating into the material by rotation, characterised in that a coolant-lubricant is supplied during the cutting operation and a cleaning agent is supplied after the cutting operation.

17. Method according to claim 16, characterised in that the coolant-lubricant is supplied at a small volume flow rate and the cleaning agent is supplied at a greater volume flow rate relative to the latter.
